(19) United States
(12) Patent Application Publication
(10) Pub. No.: US 2009/0126137 A1
(43) Pub. Date: May 21, 2009

(54) Layered Whiteboard Cleaning Tool and Method of Production

(75) Inventor: Edward F. Lyons, Riverside, IL (US)

Correspondence Address: VEDDER PRICE P.C., 222 N. LASALLE STREET, CHICAGO, IL, 60601, US

(73) Assignee: FILTRATION GROUP, INC., Joliet, IL (US)

(21) Appl. No.: 11/941,674

(22) Filed: Nov. 16, 2007

(51) Int. Cl. B43L 21/00; A47L 13/00; D01G 15/00; A47L 25/00

(52) U.S. Cl. 15/210.1; 19/98

(57) ABSTRACT

The present disclosure relates generally to a tool for removing dried ink from whiteboards using a bonded media made of intertwined surface fibers in a semi-compact, sponge-like material. In one embodiment, the bonded media is made of laminated polyester or PVC with alternating high-melt and low-melt fibers to create weak layers in the bonded media. The bonded media is placed on a pad, mitten, or glove and bonded to a scrim.

### FIELD OF THE DISCLOSURE

The present disclosure relates generally to a tool for removing dried ink placed on whiteboards and a method of production thereof, and more particularly, to a handheld cleaning pad made of layers of intertwined fibers.

### BACKGROUND

Teachers and lecturers often write on large, horizontal surfaces to display information to students and attendees. Blackboards, also known as chalkboards, have been used by teachers for decades to convey information. Users hold a small cylinder of chalk or other pulverized material and write on the board by leaving particles in interstices of the stone surface in the shapes of symbols and diagrams. The particles are removed by either brushing or washing the chalk from the surface. Frequent use of a blackboard results in the need to clean up chalk dust and residue deposited on the floor or left on the brush and a loss of visual contrast resulting from a generalized lightening of the writing surface. Chalk also leaves undesirable residue on hands and clothing.

In recent decades, whiteboards have progressively replaced blackboards. Unlike blackboards, which rely on small crevices in the writing surface to collect and hold particles, whiteboards use ink-based markers where rapidly drying ink is deposited on a smooth surface. Accelerated drying is promoted by the use of solvents such as versatile alcohol. Whiteboard ink barely attaches to the surface and is left in a very thin coat. When disturbed, the ink easily pulverizes into small flakes and is removed from the surface by brushing action. Pulverized ink particles are smaller than chalk particles but must nevertheless be collected using a collection tool. Also, most ink particles are not washable and are very difficult to clean off a brush.

Several prior art devices are known to clean whiteboards. In one embodiment, a user slides a small wooden handle into a rack attached to the whiteboard designed to hold a succession of individual flat cleaning pads. An adhesive is coated on the underside of the wooden handle and each pad attaches to the handle upon contact. This system fails in many respects. For example, a storage device for the wooden handle must be attached to the whiteboard and cannot be secured between uses, leaving pads vulnerable to theft in a classroom environment. Further, the use of adhesive or other fixation device is greatly impaired by the presence of pulverized ink. Additionally, replacement of pads requires the extended manipulation of duty surfaces by the user. Finally, pads, holders, and brushes must be managed separately.

In yet another prior art device shown in FIGS. 1-2, a plurality of cleaning sheets are attached using an adhesive layer between each other. The cleaning sheet package is then attached to a glove as shown in FIG. 1 or to a hand wipe as shown in FIG. 2. The prior art contemplates the use of rolls of multilayer stacks, such as a roll of paper towels, most preferably a roll where each successive layer includes adhesive for easy attachment and peeling. This system also fails in many respects. Frictional forces between successive layers clinging to each other via static electricity or stacking forces cause warping of the layers when the package is used. This friction-based system also loses traction when a plurality of sheets are stacked. Further, if an adhesive layer is placed on one side of the sheet, then the sheet is made opaque with a surface finish that serves as an obstacle to the collection of ink particles. Finally, multilayer rolls or stacked layers with adhesive layers lose porosity and capacity to store and distribute pulverized ink.

What is needed is a whiteboard cleaning tool that does not exhibit the disadvantages associated with the use of removable pads to be stored away from the cleaning tool and that is designed for self-cleaning without the problems associated with holding successive cleaning layers adhesively or reverting to loose layers held by surface tension only.

### SUMMARY

The present disclosure relates generally to a tool for removing dried ink from whiteboards using a bonded media made of intertwined surface fibers in a semi-compact, sponge-like material. In one embodiment, the bonded media is made of laminated polyester or PVC with alternating high-melt and low-melt fibers to create weak layers in the bonded media. The bonded media is placed on a pad, a mitten, or a glove and is bonded to a scrim.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is a perspective view of a cleaning glove according to one embodiment from the prior art.

FIG. 2 is a perspective view of a cleaning mitten according to another embodiment from the prior art.

FIG. 3 is a partially exploded perspective view of the whiteboard cleaning tool with a rectangular pad, a scrim, and a bonded media according to an embodiment of the present disclosure.

FIG. 4 is an exploded perspective view of the whiteboard cleaning tool of FIG. 3 having part of the bonded media stripped away according to the above embodiment of the present disclosure.

FIG. 5 is a close-up view of the detail as shown in FIG. 4 according to the above embodiment of the present disclosure.

FIG. 6 is a top view of a whiteboard cleaning tool in the shape of a mitten according to another embodiment of the present disclosure.

FIG. 7 is a partly exploded perspective view of the whiteboard cleaning tool of FIG. 6 according to the above embodiment of the present disclosure.

FIG. 8 is a side view of the whiteboard cleaning tool of FIG. 6 according to the above embodiment of the present disclosure.

FIG. 9 is a schematic illustration of possible successive steps of a method for producing a cleaning pad for a whiteboard cleaning tool according with another embodiment of the present disclosure.

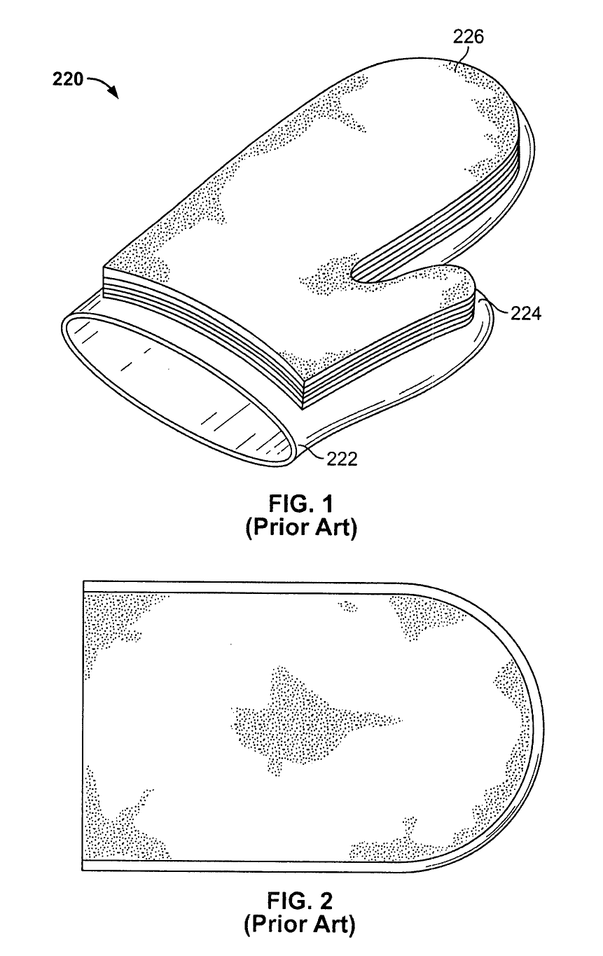

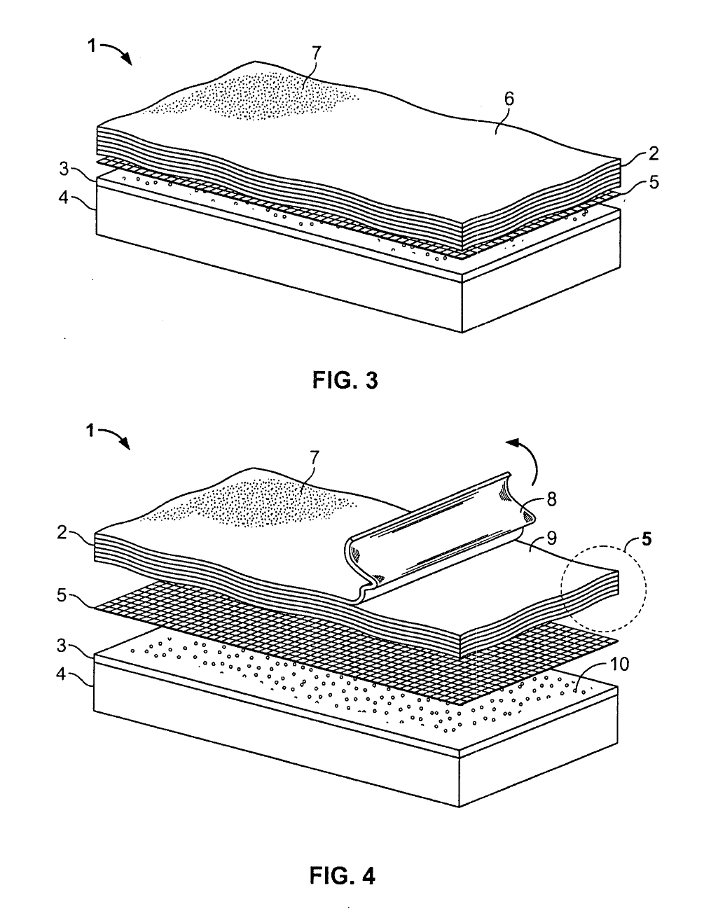

### DETAILED DESCRIPTION

FIG. 3 is a partially exploded perspective view of the whiteboard cleaning tool 1 including a rectangular pad. 4, a support 3, and a cleaning pad made of a scrim 5 and a bonded media 2 in a stacked configuration. In one embodiment, the tool 1 includes a pad 2 shown as a rectangular structure made of a material with sufficient tensile strength to be handled manually and used in contact with a whiteboard. Possible pad materials include but are not limited to wood, plastic, resin, ceramic, metal, varied composite, Styrofoam, fiberglass, or any other material as known by one of ordinary skill in the art. In the embodiment shown in FIG. 3, a support 3 such as a small aluminum plate is used to cover the pad 2 and serve as support for an adhesive 10 and a scrim 5 attached to the bonded media 2. For example, the support 3 may serve to hold an adhesive 10 that would otherwise interact chemically with the pad 2. In another example, the support 3 includes another type of fixation aside from the adhesive 10 for holding the scrim 5, such as but not limited to magnets, clips, tabs, sliding rulers, clamps, etc.

When moved on the surface of a whiteboard, the tool 1 is capable of collecting dried ink 7 left by a whiteboard marker or any other drawing device by pulverizing the dried ink by frictional contact between the upper section of the bonded media 2 and the ink. What is known in the art is the use of alcohol or other solvents with a high degree of volatility in the air, which when mixed with ink tend to leave dried ink that may be easily removed from whiteboards. In one embodiment, the bonded media 2 is made of a plurality of layers of fibrous material made of intertwined fibers with alternate layers of low-melt fibers and high-melt fibers between adjacent layers.

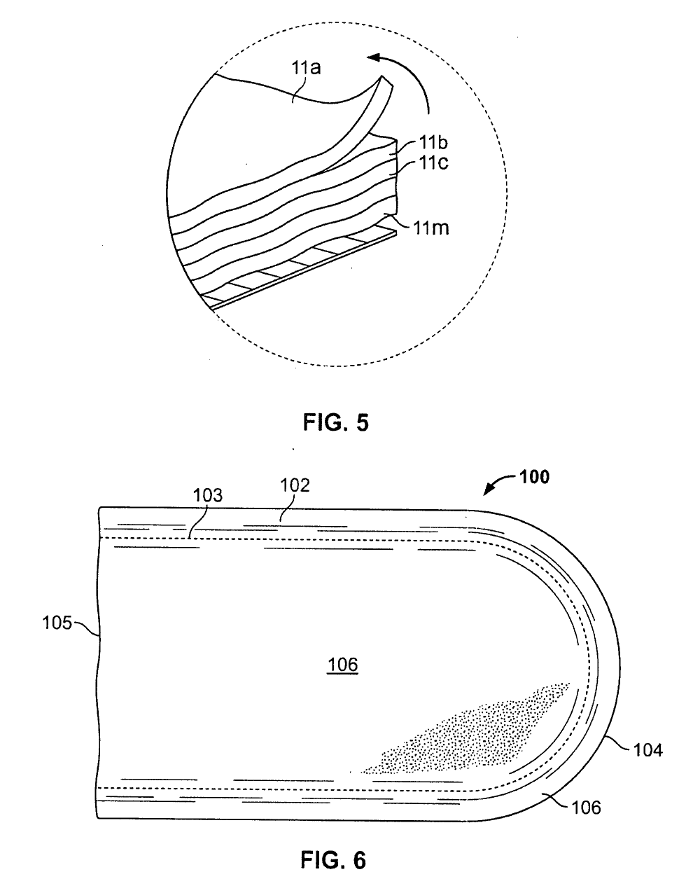

In one embodiment, the bonded media 2 is made of a thick, uniform-looking media of white or off-white color having the consistency of material used for industrial filters. What is shown as layers 8 in FIG. 4, which can be peeled away from the bonded media 2, is a series of effective layers created as the result of the method of producing the cleaning pad as described hereinafter using a carding machine to cross-link fibers. In one embodiment, the layers 8 can be perceived via visual inspection, although with some difficulty. Layers 8 of the bonded media 2 are not in fact stratified but arc cross-linked and stratified as a result of the production method that creates weak areas within the bonded media 2. By way of example, the removal of a top layer 6 from the bonded media 2 covered with ink particles 7 and replacing it 8 with a top layer 9 free of ink particles 7 is shown in FIGS. 3-4 and can be made by pinching the bonded media 2 and lifting part of the material. Unlike other erasers having successive layers of paper or tissue with adhesive, the top layer 8 in FIG. 4 is shown having a symbolic thickness of bonded media 2 being removed. The use of a bonded media 2 having layers of limited thickness results in the capacity to remove more than a single thickness as need arises. For example, if the bonded media 2 has large, porous holes in the fibers, the ink particles 7 removed from a whiteboard stabilizes deeper in the bonded media 2. To remove most of the ink particles 7 from the bonded media 2, it may be necessary to remove several layers of bonded media 2 in a single operation or in successive operations. FIG. 5 shows in detail how successive layers 11a, 11b, 11c, . . . 11m can be stacked indiscriminately over a scrim to form the bonded media 2. What is shown as a straight line between layers is in actuality a mesh of small, fibrous, woven material. Not unlike a hook and fastener structure where a first side of a multilayered structure is covered with hooks and the second side of another adjacent layer in the multilayer structure is covered with fasteners that intertwine upon contact and can be pulled apart by shearing force, the bonded media 2 is made of carded layers of fibers that are melted in an oven to create zones of strength and weakness in alternating succession. Low-melt fibers result in layers that can be pulled apart with minimal force but are held together by cross-linked melted fibers uniting successive layers.

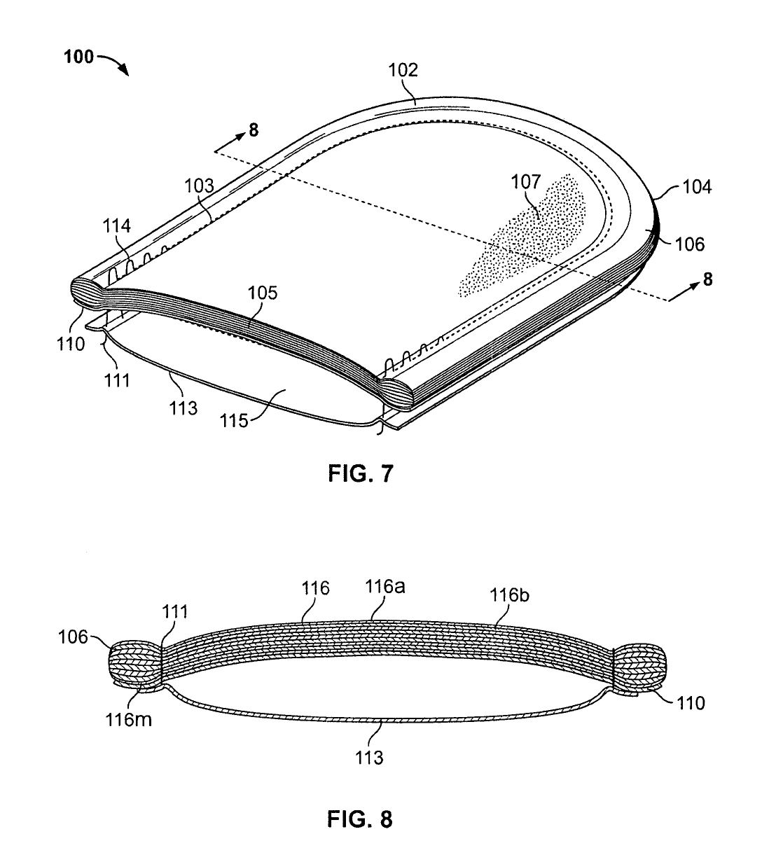

In other embodiments shown in FIGS. 6-8, instead of a rectangular shape, the bonded media 2 can be cut directly in the shape of a mitten 100, glove, or any other suitable shape. What is shown in FIGS. 6-7 is a mitten 100 having a cleaning surface 106 where ink particles 107 attach. The mitten 100 can also have a rounded end 104 or any other end as known by one of ordinary skill in the art. In the case of a mitten or a glove, the user does not need to grasp a piece of wood or other equivalent material to which the bonded media 102 is attached. Rather, the user can slide a hand or a tool within 115 the mitten 100 or glove. A support tissue 113 to construct a mitten 100 is woven 111 into the bonded media 102 and stitched 103 using any known stitching method. A layer of scrim 110 is directly attached to the bonded media 102. In one preferred embodiment, the scrim 10 or the scrim 5 shown as FIGS. 3-4 is made of a laminated layer of polyester and PVC in regular mesh-formed tissue with openings of about 1 mm in size.

In one embodiment, the plurality of layers of fibrous material is made of successive layers of polyester fiber with tear-off strength of 5 to 10 Newton per 5 centimeters. In another embodiment, the tool 1 or 100 is made of a plurality of layers or is made of a successive build-up of polyester fibers of 3.3 to 6.7 dtex and low-melt fibers of 2 to 4 dtex. In another embodiment, the total thickness of the plurality of layers of the bonded media 2 or 102 is approximately 22 mm. FIG. 8 is a side view of the mitten 100 showing how the different possible layers 116a, 116b, to 116m can be assembled with the scrim 110 to produce the whiteboard cleaning tool 100.

What is also contemplated and shown in FIGS. 6-8 is a configuration where all layers are stitched, sewn or connected in a like manner and where the top layer to be removed must first be pinching and pulled apart from successive layers or adjacent layers by breaking melted fibers in a layer of low-melt fibers and ripping the layer away from the tool by breaking the fibrous material of the layer next to the stitched portion. It will be recognized by one of ordinary skill in the art that a stitched connection also contemplates any other sealing technologies, including without limitation radio frequency or ultrasonic sealing or the like, that may point bond the layers.

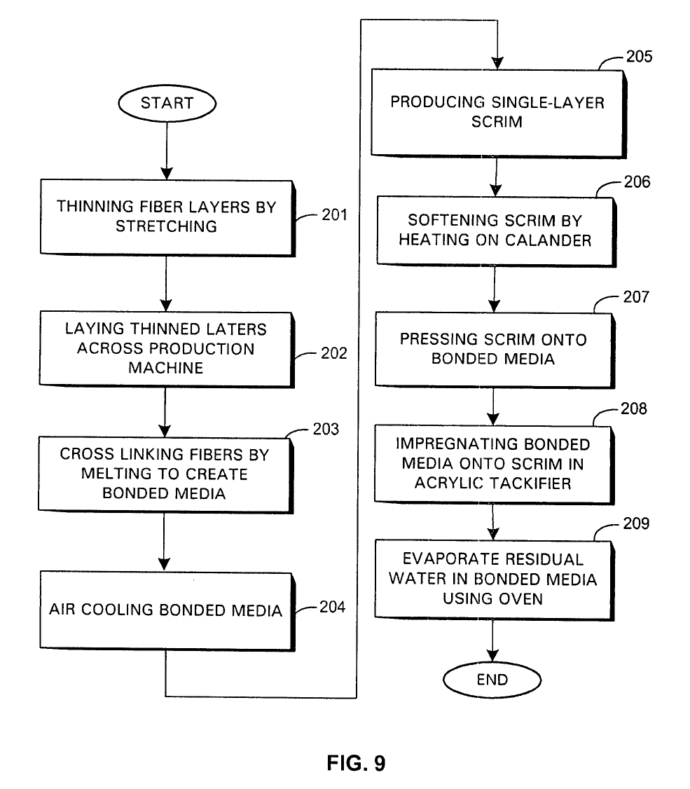

What is also contemplated and illustrated in FIG. 9 is a method for producing a cleaning pad for a whiteboard cleaning tool 1 or 100. FIG. 9 is a schematic illustration of possible successive steps of a method for producing a cleaning pad for a whiteboard cleaning tool according to another embodiment of the present disclosure. In successive steps, what is contemplated is the creation of successive layers of polyester fibers and low-melt fibers on a carding machine 200 by first thinning 201 the layers of polyester fibers and low-melt fibers by stretching via the carding machine, laying 202 the thinned layer across a production machine, cross-linking 203 the low-melt fibers by over-melting to create a bonded media, and cooling 204 the bonded media using cooling air.

The method also further includes the additional steps of producing 205 a single-layer scrim, softening 206 the scrim by heating on a calander, and pressing 207 the scrim onto the bonded media 2. In yet another embodiment, the method also includes the additional steps of impregnating 208 the bonded media to the scrim in an acrylic tackifier and evaporating 209 residual water in the bonded media in an oven.

It is also understood by one of ordinary skill in the art that these steps correspond to the general steps to be taken to practice the methods of this disclosure. Other auxiliary steps may be taken but do not affect the validity and completeness of the disclosure of this general method. Persons of ordinary skill in the art appreciate that although the teachings of the disclosure have been illustrated in connection with certain embodiments and methods, there is no intent to limit the invention to such embodiments and methods. On the contrary, the intention of this application is to cover all modifications and embodiments falling fairly within the scope of the teachings of the disclosure.

What is claimed is:

1. A whiteboard cleaning tool, comprising:
a cleaning pad for collecting dried ink particles from a whiteboard, the cleaning pad made of a scrim and a bonded media made of a plurality of layers of fibrous material made of intertwined fibers with alternate layers of low-melt fibers and high-melt fibers between adjacent layers, and a means for holding the cleaning pad.

2. The whiteboard cleaning tool of claim 1, wherein the cleaning pad is in the shape of a rectangle.

3. The whiteboard cleaning tool of claim 1, wherein the cleaning pad is in the shape of a mitten.

4. The whiteboard cleaning tool of claim 1, wherein the cleaning pad is in the shape of a glove.

5. The whiteboard cleaning tool of claim 2, wherein the means for holding the cleaning pad is a rigid rectangular plate.

6. The whiteboard cleaning tool of claim 3, wherein the means for holding the cleaning pad is a mitten.

7. The whiteboard cleaning tool of claim 4, wherein the means for holding the cleaning pad is a glove.

8. The whiteboard cleaning tool of claim 1, wherein the cleaning pad further comprises a scrim for supporting the plurality of layers of fibrous material.

9. The whiteboard cleaning tool of claim 8, wherein the scrim is a laminated polyester/PVC layer.

10. The whiteboard cleaning tool of claim 1, wherein the plurality of layers of fibrous material are made of successive layers of polyester fiber with tear-off strength of 5 to 10 Newton per 5 cm.

11. The whiteboard cleaning tool of claim 10, wherein the plurality of layers is made of a successive build up of polyester fibers of 3.3 to 6.7 dtex and low-melt fibers of 2 to 4 dtex.

12. The whiteboard cleaning tool of claim 11, wherein the total thickness of the plurality of layers is approximately 22 mm.

13. The whiteboard cleaning tool of claim 1, wherein layers are stitched and removed by pinching a surface layer to be removed, pulling part of the layer away from an adjacent layer by breaking melted fibers holding the layer in place, and ripping off the fibrous material of a layer next to the stitched portion.

14. A method for producing a cleaning pad for a whiteboard cleaning tool, comprising the steps of creating successive layers of polyester fibers and low-melt fibers on a carding machine by:
thinning the layers by stretching using the carding machine;
laying the thinned layer across a production machine;
cross-linking the low-melt fibers by oven-melting to create a bonded media; and
cooling the bonded media using cooling air.

15. The method for producing a cleaning pad for a whiteboard cleaning tool of claim 14, further comprising the steps of:
producing a single-layer scrim;
softening the scrim by heating on a calander; and
pressing the scrim onto the bonded media.

16. The method for producing a cleaning pad for a whiteboard cleaning tool of claim 15, further comprising the steps of:
impregnating the bonded media to the scrim in an acrylic tackifier; and
evaporating residual water in the bonded media in an oven.
